(19) United States
(12) Patent Application Publication
(10) Pub. No.: US 2005/0204293 A1
(43) Pub. Date: Sep. 15, 2005

(54) Method and system of displaying an instantaneous summary of selections of a listbox

(76) Inventors: Sangeetha Raghunathan, Lansdale, PA (US); Jerry Kagan, Devon, PA (US)

Correspondence Address: BAKER & BOTTS, 30 ROCKEFELLER PLAZA, NEW YORK, NY, 10112, US

(21) Appl. No.: 10/416,984

(22) PCT Filed: Apr. 25, 2002
(86) PCT No.: PCT/US02/13278

§ 371 Date: Oct. 23, 2003

Related U.S. Application Data
(60) Provisional application No. 60/334,476, filed on Nov. 16, 2001.

(51) Int. Cl. G06F 3/00

(52) U.S. Cl. 715/739; 715/826

(57) ABSTRACT

This invention proves a system and method for displaying an instantaneous summary of selections of a listbox used in graphical user interfaces. As a user selects one or more items from a listbox, these items are displayed in a summary display without the user having to use additional controls or instructions to provide this information in the summary.

### CROSS REFERENCE TO RELATED APPLICATION

This application is based on provisional application serial number 60/334,476, filed Nov. 16, 2001, upon which priority is claimed.

### FIELD OF THE INVENTION

This application relates to controls for a graphical user interface. More particularly, this invention relates to a listbox control for a graphical user interface providing summary information about items selected from the listbox.

### BACKGROUND

A listbox control is a commonly used control in a Graphical User Interface (“GUI”) application that allows a list of items to be shown within a listbox. One such listbox 101 is shown in FIG. 1. Typically, listboxes 101 show a list of items for selection wherein each item is provided on its own line, being placed vertically one after another.

Listboxes 101 can be provided to shortlist one or more items from a respectively longer list of items. The listbox 101 is provided with a horizontal and vertical scroll bar. These scroll bars can be turned ON or OFF based on the design of the application. The scroll bars are used to navigate through the contents of the listbox 101 that extend beyond the physical size of the listbox 101. The horizontal scroll bar permits the user to display portions of an item, such as the end of a long name or phrase, which would otherwise extend beyond the wdth of the listbox 101. Usually, the height of the listbox 101 is insufficient to display all the items at once. The vertical scroll bar is then used to navigate through the list of items. While scrolling, the items may scroll off the top or bottom of the listbox 101. Thus, the size of a listbox 101 limits the number of items that can be simultaneously shown at one time.

Often listboxes 101 are provided to permit a user to select one or more items from a single-column list shown in the listbox 101. Items in a list can be selected by a user through an interface device, such as keyboard or a mouse. For example, a listbox 101 can be provided for a user to select or deselect one or more items from the list by placing a cursor over the item to be selected and clicking the left button of a pointing device. The user can select contiguous items from the list, or several items separated by one or more unselected items. For example, by using a pointing device such as a mouse in cooperation with a keyboard, a user can select a group of contiguous items by holding down the shift-key while selecting the first item to be selected and the last item to be selected with the pointing device. Alternatively, the user can select a non-contiguous grouping in a listbox 101 by using the control-key in cooperation with a pointing device such as a mouse for selecting the desired items.

Where the user selects a number of items from a large list, it can be necessary for a user to utilize the vertical scroll bar in order to scan through the items within the list since the size of the listbox 101 limits the number of items that are simultaneously visible. In pre-existing applications of listboxes 101, it was difficult for a user to keep track of selected items. If the user wanted to keep track of the number of items selected, utilizing existing listboxes 101, the user would have to manually traverse the entire list and count the number of items selected. Thus, keeping track of selected items by requiring a user to scroll up and down through the list to view the selections makes the process tedious, confusing, time consuming and prone to mistakes.

Another failing of pre-existing applications of listboxes 101 is that under certain circumstances, a listbox 101 displayed to the user could contain no visible selected items but would actually contain selected items. Thus, existing applications can mislead the user into thinking that no items had been selected. Further, depending on the implementation of the control permitting selection of multiple items such as holding down the control-key, if the user inadvertently selected an item in a listbox 101 where items had already been selected, all previous selections would be lost.

The objective of displaying the summary of a selection of the listbox 101 is to allow the user using an application with a graphical user interface to keep track of the items selected in the listbox 101 while in the process of selection. It is also helpful to track items when editing default selections, or when editing selections populated from a previous session. Such a display provides the user with a clear picture of the selected items and is extremely helpful to a user, particularly in cases when the number of items in the listbox is large. Since items that have been selected can scroll off the top or bottom of the listbox 101 when large lists are involved, the process of keeping track of selected items becomes tedious, confusing, and time consuming, requiring the user to scroll up and down through the list to view the selections made. In addition, if the user wants to keep track of the number of items selected, the only way would be to manually traverse the entire list and count the number of items selected.

Thus, pre-existing listboxes 101 have a number of problems. In pre-existing applications, selected items may not be visible which can result in an erroneous selection and thereby permit loss of previous selections. Pre-existing applications are time consuming and tedious to keep track of selected items. In addition, pre-existing applications required that the number of items selected be manually counted.

One attempted solution to these problems has been to provide listboxes 101 with a second listbox 101, as well as two or more separate controls for adding or removing selected items from the second listbox 101. One such implementation of a two-listbox 101 solution is shown in FIG. 2. Control buttons 201 are used to transfer items between the two listboxes 101. In this approach, the second listbox 101 stores a separate list of selected items for display in the separate selection box.

Use of two listboxes 101 with control buttons 201 also suffers from a number of disadvantages. Existing implementations require two or more control buttons in addition to the second listbox and require additional control instructions from a user to achieve the listbox selection summary. The user must select one or more items from either the first or the second listbox 101 and then activate one of the control buttons to add or remove the item from the selection list. The contents of a listbox 101 are not updated until selected items have been transferred from the other listbox 101 with at least one additional user instruction.

Accordingly there is a need to provide a method and system of displaying an instantaneous summary of selections of a listbox 101 that addresses the aforementioned problems.

### SUMMARY OF THE INVENTION

It is an object of the invention to provide a summary display control for displaying items selected from a listbox without requiring additional user instructions while facilitating a users ability to track selected items.

It is a further object of the invention to provide a summary display control for displaying items selected from a listbox without requiring additional listbox controls.

An additional object of the invention is to provide a summary display control that automatically updates a summary when items in a listbox are selected or deselected.

Another object of the invention is to provide a summary display control for displaying items selected from a listbox without requiring an additional listbox and providing a simplified programming code.

Accordingly, a summary control program is provided that creates a summary display from a listbox. The summary control program provides the user with an instantaneous summary of the selections made. The user can select an item and the program automatically updates the summary display. Then the user can select another item, and the program automatically updates the summary display again. If the user deselects a previously selected item, summary display is updated. If a user chooses a range of items simultaneously using (SHIFT/CTRL), the summary display is updated with each selection by the program. Thus, the system and method according to the invention provides that the summary display is updated as selections are made or changed in the selection listbox. In this way the user is always presented with the most recent summary of selected items

In conventional methods, the user does not view the selection until it is transferred to a second listbox by a user action. Additionally, conventional two-listbox methods do not display a count of the number of items selected. The summary control program also requires fewer lines of code than the alternative pre-existing solutions discussed above and is a faster solution than utilizing separate listbox controls.

For example, selecting five consecutive items using the conventional two-listbox method requires a minimum of three clicks:

(1) Click first item to be selected in first listbox;

(2) Click last item to be selected in first listbox, holding SHIFT key down; and

(3) Click button to transfer to second listbox.

In contrast, the summary control system and method on the other hand requires only two clicks:

(1) Click first item to be selected in first listbox; and

(2) Click last item to be selected in first listbox, holding SHIFT key down.

Accordingly, a system and method for displaying an instantaneous summary of selections of a listbox is provided. A summary control program in accordance with the invention can be provided as a software arrangement and can be stored on a computer usable medium. The summary control program includes initializing variables, checking for selected items in the listbox, creating a summary list, and displaying the summary list in a summary list display.

When checking for selected items, the summary control program can further be provided with processing steps for displaying an empty summary list in a summary list display if no items are selected. When checking for selected items, the summary control program can further be provided with processing steps for counting the number of items in the listbox processed up until the current point in execution in an outer loop, determining if each item in the listbox is selected, and adding each selected item to a selected item string in an inner loop. In addition, while adding each selected item, the summary control program can further be provided with processing steps for counting the number of selected items, and displaying the number of selected items.

### BRIEF DESCRIPTION OF THE DRAWINGS

A more complete understanding of the present invention may be obtained from consideration of the following descriptions, in conjunction with the drawings, of which:

FIG. 1 is a representation of a portion of a graphical user interface (GUI) having a listbox;

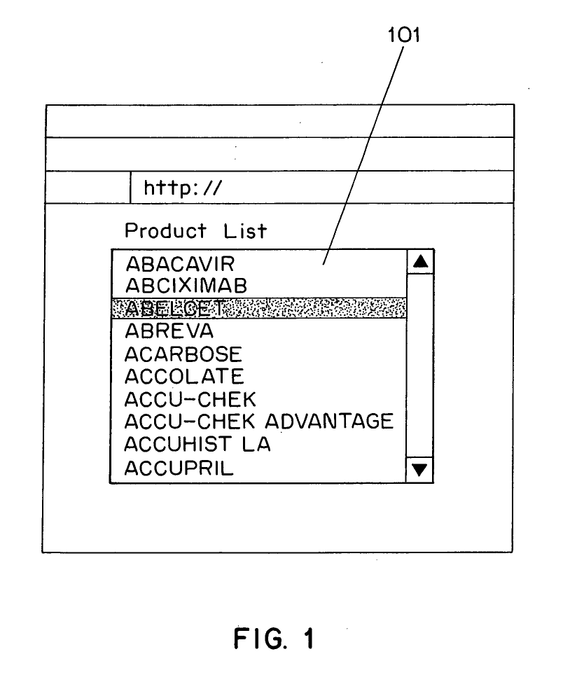

FIG. 2 is a representation of a portion of a GUI having two listboxes and control buttons;

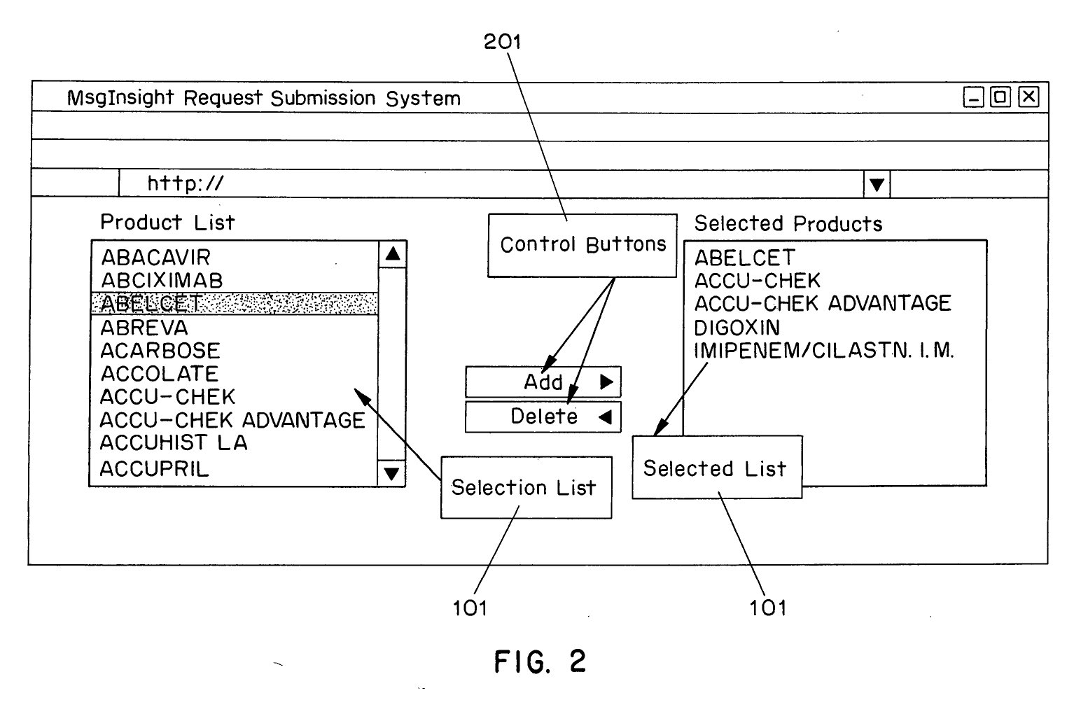

FIG. 3 is a representation of a portion of a GUI having a listbox and listbox summary according to the invention;

FIG. 4 is a flowchart showing several processing steps of the method according to the invention.

Throughout the figures, the same reference numerals and characters, unless otherwise stated, are used to denote like features, elements, components or portions of the illustrated embodiments.

### DETAILED DESCRIPTION OF THE PREFERRED EMBODIMENTS

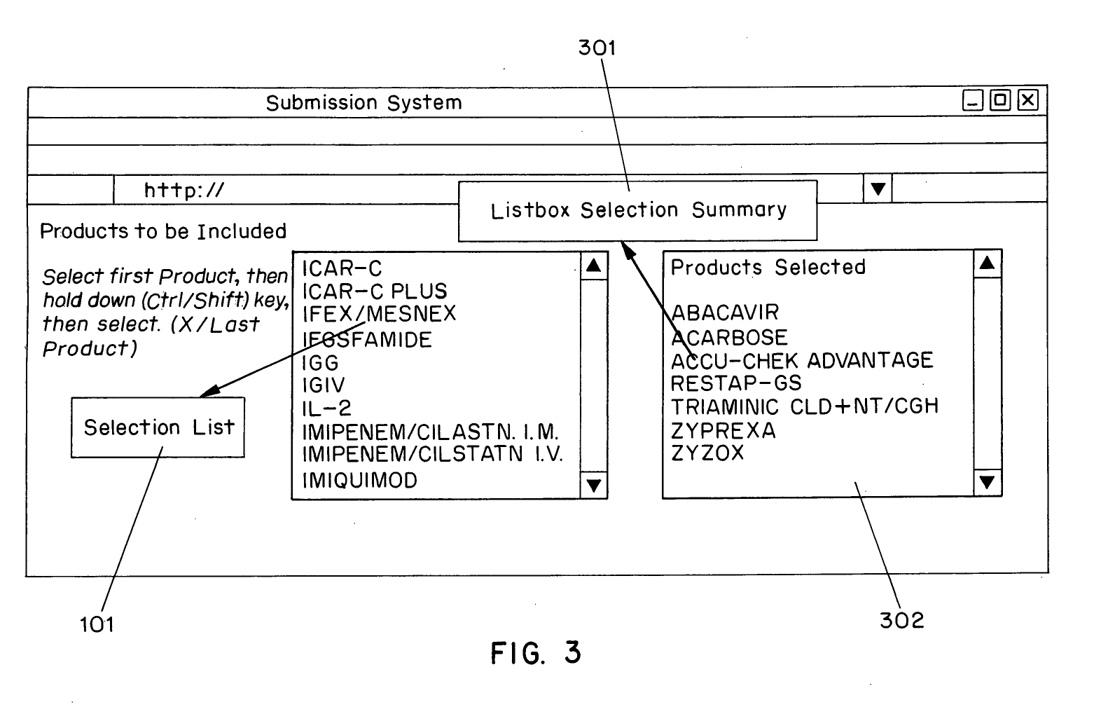

In order to solve the aforementioned problems, a method and system for displaying an instantaneous summary of selections of a listbox 101 is provided. FIG. 3 shows one embodiment of a listbox 101 with summary display 301 according to the invention. A summary control program in accordance with the method of the invention is provided to control the listbox 101 and summary display 301 as described below. The summary control program is a computer enabled software routine that provides for multi-line text control and can be integrated with other software or it can stand-alone for a particular use of a listbox 101.

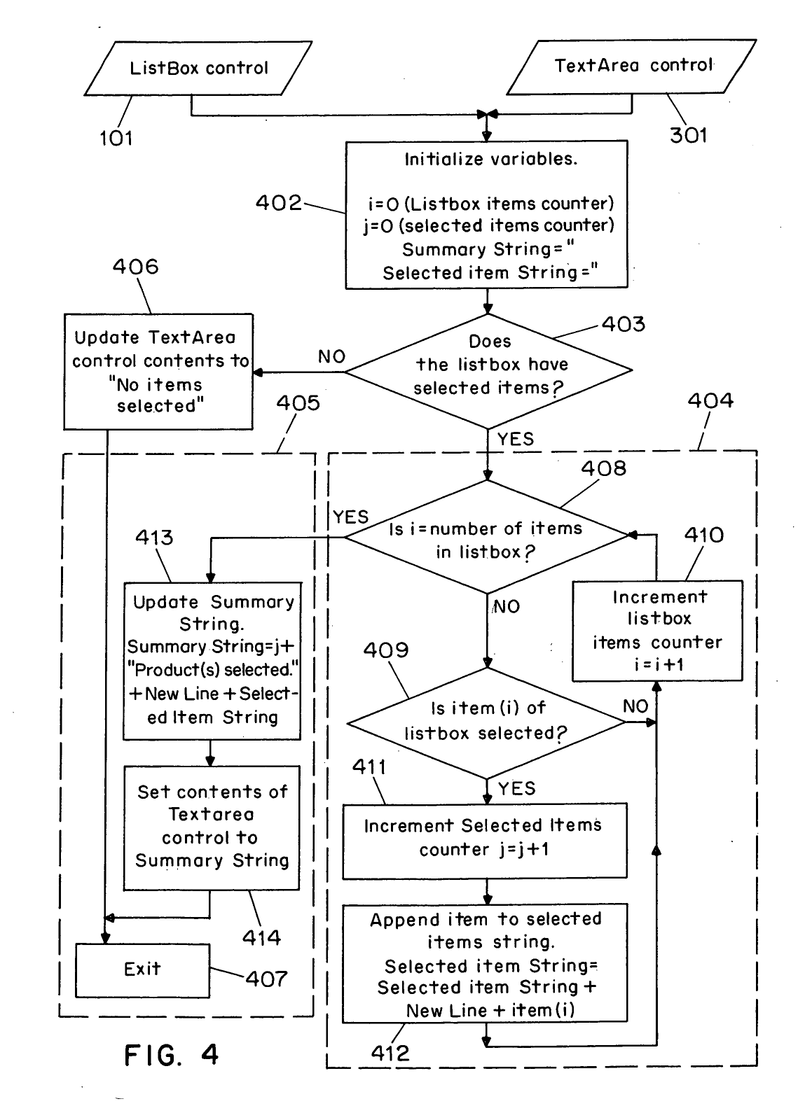

One specific set of logical steps for a summary control program 401 according to the invention is shown in FIG. 4. One of ordinary skill in the art would be able to program variations to the routine in FIG. 4 without deviating from the spirit and scope of the invention. The summary control program 401 can be programmed using JavaScript, VBScript, Visual Basic, or the C programming language, among other programming languages. The summary control program 401 can be incorporated into regular use with other graphical user interfaces or it can be provided as an independent unit such as by programming as part of a dynamically-linked library. An exemplary summary control program is included as part of this specification as Appendix I.

A summary control program 401 according to the invention provides that when a user selects one or more items in a listbox 101, the selected items in the listbox are displayed in a summary display 301. When one or more items of a listbox 101 associated with the summary control program 401 are selected, the control program will automatically update the summary display 301 to reflect any items selected by the user.

In addition, an embodiment of the system and method according to the invention can be provided with programming steps that provide for a display of a summary number 302 representing the number of selected items without the necessity of providing an additional control button or feature for a user to request this information.

A series of steps according to the invention is shown in a flowchart in FIG. 4. These steps can be programmed as the processes of a summary control program 401. The programmed method is intended to be employed for use with a graphical user interface having listbox 101 and summary display 301 objects. The summary display 301 objects can include any control that supports multi-line contents like a text area or a rich text box, for example. When a user activates a listbox 101 associated with a summary display 301, or text area as in the current example of the application, the software running the graphical user interface passes control information designating the particular listbox 101 and summary display 301 to the summary control program 401. This initiates the processes of the program.

One step in an embodiment of the system and method according to the invention is initializing variables 402. In such a step, variables to be used by the control program 401 are set to initial values. In the routine programmed in Appendix I, the routine has been named UpdateListboxSummary. Initial values for numerical variables can be set to values such as 0. Initial values for string variables can be set to values equivalent to empty strings. In one embodiment of the system and method, counter variables called “i” and “j” are used to represent amounts to be counted during the routine. It can be appreciated by one of ordinary skill in the art that other variable names can be used.

In one embodiment of the initializing step 402, initializing code is provided wherein two indexing variables can be initialized. A first index variable “i” is used as an index, or placeholder, for the listbox item currently being processed by the summary control program 401. This variable is incremented for every item in the listbox 101. A second index variable “j” is used as an index of the number of selected items encountered up to the current point of the execution of the routine. The variable is incremented each time a selected item is found.

Other variables can also be initialized by an initializing step 402. For example, a variable arbitrarily named SelectedltemString has been chosen to represent a concatenation of items selected in listbox 101. It can be appreciated that the naming convention for the several variables can be made according to the choice of the programmer. Similarly, a variable called SummaryString has been used to store the textual representations of the items selected and the number of items selected to be listed in the summary display 301.

Another step in the method is checking for selected items 403. A part of this step is checking to see if the listbox 101 contains any selected items at all and can be provided by a programming module for checking the listbox 403. If no items have been selected, the summary display 301 or area where the summary text is to be displayed is updated to indicate that no items are selected and processing stops. The updating and displaying of the summary list 301 in this circumstance can be provided by a “no items” display step 406. A “no items selected state” can simply provide an empty summary display 301.

An important aspect of the step of checking for selected items 403 is that it transfers control to two basic blocks of the process, one block of processing is invoked when items are selected and another block of processing is invoked when no items are selected. When no listbox 101 items are selected, this step saves valuable processing time and resources.

Another step is provided when the listbox 101 contains items that are selected. This step in the method involves creating a summary list 404. The step of creating the summary list 404 provides an outer loop check 408 for determining if the current value of counter variable “i” is equal to the number of items in listbox 101. In addition to the outer loop check 408, the step of creating the summary list 404 includes an incrementing step 410 for the variable “i” that advances the counter by 1. This step forms the outer wrapper for creating the summary string. The loop functions by incrementing the counter variable “i”, meaning that processing proceeds to the next listbox 101 item. The loop is broken by the outer loop check 408 when the value of “i” is equal to the number of items in the listbox 101 which implies that all items in the listbox 101 have been processed and the creation of a string of selected items is complete. It should be noted that since this variable is also used as an index for the listbox 101 items, the valid values for this variable are from zero to one less the number of items in the listbox 101. The index of the last item in the listbox 101 is one less than the number of items in the listbox 101.

A further part of the step of creating a summary list 404 is an inner loop check 409 for checking each item of the listbox 101 and determining if it is selected. If the item is selected then processing of the listbox item is continued. If not, processing is continued with the next listbox item.

If an item is selected, another step in creating a summary list 404 is incrementing the selected items counter 411. In the example provided, “j” is the selected items counter. This step is executed for a listbox 101 item that is selected. The counter variable “j” keeps track of the number of selected items encountered in the loop. The variable value can be used later to provide the total number of items selected and shown in the summary display.

Thus, valid variable values for the indexing variables are as follows:
i={0 to n−1}, where
   n=number of items in the listbox 101, and
   i=index variable for the listbox 101; and
j={0 to n}, where
   j=counter for keeping track of the number of selected items.

A further part of the step of creating a summary list 407 if an item is selected is adding 412 the selected item to a string to be shown in the display 301 summary. The selected item is appended to a variable that can contain a string of other selected items previously appended by this step. A variable such as SelectedltemString can be used for this purpose. In addition, a new-line character is appended after each previously selected item appended in the SelecteditemString and before the new selected item to be appended by this step. Thus, the string contents come to resemble the contents of the summary display 301.

In one embodiment of the method, the summary display 301 is provided with a first line showing the total number of items selected 302, followed by a blank separator line and then the list of selected items from the selected items string. For the very first selected item that is encountered, the statement shown in FIG. 6, SelectedItemString=SelectedItemString+NewLine+item(i), provides an empty line before the first item in the summary. Thus, the empty line can provide a division between the number of items selected and the list of selected items.

Another step in the method is displaying the summary list 405 with the list of items selected. This step is executed when the parsing of the listbox items into a summary list string provided in the creating step 404 is complete. In the example provided, this occurs when the value of variable “i” is equal to the number of items in the listbox 101 as determined by the outer loop check 408. The summary display 301 is formed from the number of selected items and the contents of the string representing the selected items.

For example, the final summary can be provided by a variable:
SummaryString
={j+NewLine+SelectedltemString} or, for example
={j+“Item(s) selected”+NewLine+SelectedltemString}.

It can be appreciated by one of ordinary skill in the art that an additional step of adding description text 413 can provide a first line indicating the number of items selected along with a description string such as “Product(s) selected.” It can be further appreciated that this first line can be modified or omitted from the summary box and alternative programming code can provide this summary information elsewhere, such as above the summary display 301.

Once all the summary information to be displayed has been collected, a further step of displaying 414 the information is provided which can include passing the summary information to the summary display 301 or other text area. In the programmed routine shown in FIG. 6, the entire summary is applied to a Textarea control simultaneously and is therefore much faster than using a separate listbox 101 control for showing a summary list. At this point, the routine running the summary method is exited 407 and control is returned to other software processes.

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are felt to be within the scope of the appended claims.

1. A method for displaying an instantaneous summary of selections of a listbox, comprising the steps of:
initializing variables;
checking for selected items in the listbox;
creating a summary list; and
displaying the summary list in a summary list display.

2. The method according to claim 2, wherein the step of checking for selected items further comprises the step of displaying an empty summary list in a summary list display if no items are selected.

3. The method according to claim 2, wherein the step of checking for selected items further comprises the steps of:
counting the number of items in the listbox in an outer loop;
determining if each item in the listbox is selected; and
adding each selected item to a selected item string in an inner loop.

4. The method according to claim 3, wherein the step of adding each selected item further comprises the step of counting the number of selected items.

5. The method according to claim 1, wherein the step of displaying the summary list further comprises the step of displaying the number of selected items.

6. A computer usable medium comprising a computer program code which is configured to cause a processor to execute one or more functions comprising:
initializing variables;
checking for selected items in the listbox;
creating a summary list; and
displaying the summary list in a summary list display.

7. The computer usable medium according to claim 6, wherein the processor configured for checking for selected items is further configured for displaying an empty summary list in a summary list display if no items are selected.

8. The computer usable medium according to claim 6, wherein the processor configured for selected items is further configured for
counting the number of items in the listbox in an outer loop;
determining if each item in the listbox is selected; and
adding each selected item to a selected item string in an inner loop.

9. The computer usable medium according to claim 8, wherein the processor configured for adding each selected item is further configured for counting the number of selected items.

10. The computer usable medium according to claim 6, wherein the processor configured for displaying the summary list is further configured for displaying the number of selected items.

11. A system for executing a computer program for facilitating decision making analysis, the system comprising:
a memory device for storing the computer program thereon; and
a processor which
initializes variables;
checks for selected items in the listbox;
creates a summary list; and
displays the summary list in a summary list display.

12. The system for executing a computer program according to claim 11, wherein the processor displays an empty summary list in a summary list display if no items are selected.

13. The system for executing a computer program according to claim 11, wherein the processor
counts the number of items in the listbox in an outer loop;
determines if each item in the listbox is selected; and
adds each selected item to a selected item string in an inner loop.

14. The system for executing a computer program according to claim 11, wherein the processor counts the number of selected items.

15. The system for executing a computer program according to claim 11, wherein the processor displays the number of selected items.
